(19) United States
(12) Patent Application Publication
(10) Pub. No.: US 2024/0064122 A1
(43) Pub. Date: Feb. 22, 2024

(54) INTEGRATED ANTI-TROLLING AND CONTENT MODERATION SYSTEM FOR AN ONLINE PLATFORM AND METHOD THEREOF

(71) Applicant: Wildr Inc., San Francisco, CA (US)

(72) Inventors: Amit Roy Sharma, Sydney (AU); Melissa Ravi, San Francisco, CA (US); Vidit Drolia, San Francisco, CA (US)

(21) Appl. No.: 18/453,379

(22) Filed: Aug. 22, 2023

Related U.S. Application Data
(60) Provisional application No. 63/400,042, filed on Aug. 22, 2022.

(51) Int. Cl. H04L 51/52; G06Q 50/00; H04L 51/063; G06F 40/56; G06F 40/166; H04L 51/212; H04L 67/306

(52) U.S. Cl. CPC H04L 51/52; G06Q 50/01; H04L 51/063; G06F 40/56; G06F 40/166; H04L 51/212; H04L 67/306

(57) ABSTRACT

The present invention discloses an integrated anti-trolling and content moderation system (100) for an online platform that pioneers a transformative approach to a digital interaction. Through a Troll Detection Module (102), offensive content is thwarted at its source, while a Personalized Moderation Module (103) empowers the user to nominate moderators for pre-publication assessment, fostering transparency and accountability. Augmenting user communication, an AI-driven Suggestions Module (104) provides the user with alternative rephrasing suggestions before posting, fostering the promotion of polite and constructive communication. The system incorporates a Collaborative Moderation Module (105), enabling the collective assessment of a content by multiple moderators. A user profile management Module (106) diligently tracks and showcases true positive trolling instances, accompanied by temporary commenting restrictions following the identification of trolling behavior.

### PRIORITY CLAIM

This application claims priority from U.S. provisional application Ser. No. 63/400,042 filed on 22 Aug. 2022 entitled “METHODS AND SYSTEMS OF ONLINE SOCIAL NETWORKING”, the entirety of which is herein incorporated by reference.

### DESCRIPTION OF THE INVENTION

### Technical Field of the Invention

The present invention relates to a field of advanced content moderation and interactive communication in online platforms. Specifically, the invention encompasses a comprehensive system for combating trolling behavior, promoting politeness, and refining troll detection models through collaborative moderation. This invention addresses the challenges of online discourse by introducing real-time analysis, personalized moderation, and AI-driven suggestions, thereby fostering a healthier and more engaging digital environment.

### BACKGROUND OF THE INVENTION

In the ever-evolving landscape of digital communication, the rise of social media platforms and online communities has brought about unprecedented opportunities for global interaction and information exchange. However, this progress has also been accompanied by a significant challenge: the pervasive presence of trolling behavior that undermines meaningful discussions and inhibits constructive engagement.

The current online ecosystem lacks a robust mechanism to effectively deter and address trolling, leading to an environment where individuals are often subjected to offensive, inflammatory, or disrespectful content. This deficiency not only hampers the potential of online communities to foster genuine conversations but also poses mental and emotional well-being risks for users who experience or witness such behavior.

Furthermore, the absence of personalized and efficient content moderation tools is glaring in today's digital world. Traditional moderation approaches often rely on pre-defined rules and report-based mechanisms, which are reactive rather than proactive. This results in delayed responses to offensive content and places undue burden on content creators and recipients to manually report inappropriate posts. The lack of real-time analysis and suggestions perpetuates the cycle of negative interactions and undermines the positive aspects of online communication.

The necessity for a collaborative approach to content moderation is another aspect that is notably missing in the available. Users often lack agency in shaping the moderation process, even though they are the primary consumers of the platform's content. The absence of a comprehensive feedback loop between users, moderators, and the system itself prevents the evolution of a self-regulating and user-centric digital space.

The Patent Application No. WO2021025575A1, titled “Moderation of messages from users in a live broadcast” pertains to the realm of wireless communication networks connecting an unlimited number of users. This innovation finds utility in screening incoming live messages and signals from viewers. The proposed solution involves real-time moderation of text, voice, and video messages intended for the host of a live broadcast chat. Messages are assessed based on their content, relevance to the live broadcast's topic, adherence to censorship rules, and respectful demeanor towards participants. The moderation is executed through preliminary screening, either by the host or a designated representative, who permits messages aligning with the broadcast's subject and rules, while maintaining respect for participants, to be included in the live broadcast.

The Patent Application No. US2019026601A1, titled “Method, System and Tool for Content Moderation” addresses a computer-executable approach to moderating the publication of data content using a moderator tool. This technique involves labeling data contents as either acceptable or unacceptable. Upon receiving training data, the moderator tool employs a first algorithm to identify features present in the training data, extracting them to establish a feature space. Subsequently, a second algorithm is executed within this feature space by the moderator tool, defining a distribution of data features that distinguish between acceptable and unacceptable contents. This process aims to create a moderation model. When a new data content requires moderation, the moderator tool applies itself to the content, identifying data features in line with the established moderation model, and generating a moderation result that indicates the content's acceptability.

In conclusion, despite the advancements in technology and the prevalence of social media platforms, certain gaps persist within the digital realm of online discourse. Thus, there is a compelling need for an innovative solution that effectively bridges the deficiencies prevalent in the current online discourse landscape. The rising tide of trolling behavior and the inadequacies of existing content moderation methods underscore the urgency for a comprehensive approach that proactively curtails offensive content while nurturing a more respectful and engaging digital environment.

### SUMMARY OF THE INVENTION

The present invention introduces a solution that tackles the persistent challenges in online interactions and content moderation. It overcomes the limitations of existing approaches by implementing a real-time troll detection model, preventing the posting of offensive content at its source. Moreover, the invention empowers users with a collaborative moderation system, enabling them to nominate moderators who assess content before publication. This approach ensures transparency, accountability, and a respectful discourse. Additionally, the invention promotes politeness through AI-driven suggestions, refining user content and fostering a positive online atmosphere.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram disclosing an integrated anti-trolling and content moderation system for an online platform

FIG. 2 illustrates a flow diagram disclosing a method of anti-trolling and content moderation for an online platform

### DETAILED DESCRIPTION OF THE INVENTION

Reference will now be made in detail to the description of the present subject matter, one or more examples of which are shown in figures. Each example is provided to explain the subject matter. Various changes and modifications obvious to one skilled in the art to which the invention pertains, are deemed to be within the spirit, scope and contemplation of the invention.

The terminology used in the description presented herein is not intended to be interpreted in any limited or restrictive way, simply because it is being utilized in conjunction with detailed description of certain specific embodiments of the invention. The terms “new phrases”, “newly generated phrases” may be interchangeably used.

The present invention discloses an inventive solution that addresses the persistent challenges encountered in the realm of online interactions and content moderation. By harnessing real-time troll detection models, it effectively surmounts the limitations inherent in existing methodologies, thwarting the dissemination of offensive content at its inception. Furthermore, the invention empowers users by introducing a collaborative moderation system that grants them the authority to designate moderators for assessing content before its publication. This unique approach ensures a transparent, accountable, and civil discourse. Additionally, the invention promotes politeness through the integration of AI-driven suggestions, refining user-generated content and cultivating a positive online ambiance.

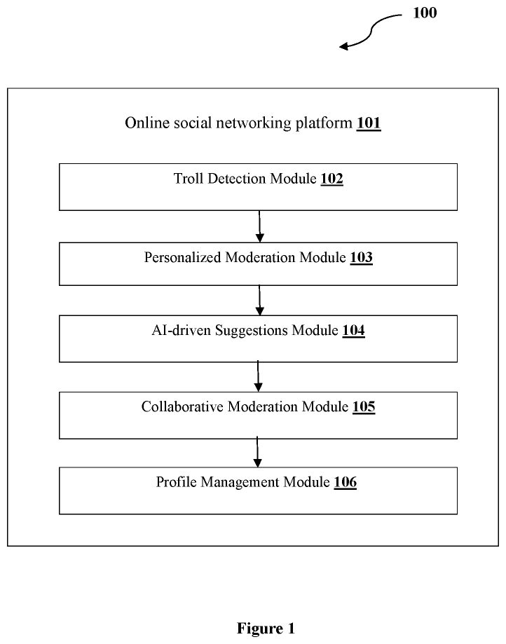

FIG. 1 illustrates a block diagram disclosing an integrated anti-trolling and content moderation system (100) for an online platform. The system is designed to cultivate a healthier online discourse environment by efficiently detecting and curbing trolling behavior, empowering users with personalized moderation options, promoting positive communication, and establishing a collaborative framework for content evaluation.

The troll detection module (102) employs a hybrid approach, incorporating both on-device and remote components to ensure prompt and accurate identification of trolling behavior. By utilizing custom tokenization and fine-tuned AI models, the troll detection module achieves remarkable precision in discerning instances of trolling, safeguarding the online community from offensive and disruptive content.

The personalized moderation module (103) empowers users by allowing them to nominate moderators who assume the responsibility of evaluating and endorsing comments and replies before they become visible to content creators or the users. This user-driven moderation approach fosters transparency and accountability, granting users the ability to shape the content environment within their personal digital spaces. Moderators play a pivotal role in ensuring that the content aligns with community guidelines and promotes respectful discourse.

To foster a culture of polite and constructive communication, the AI-driven suggestions module (104) provides users with contextually relevant alternative phrasing suggestions prior to posting. This module enhances the quality of user-generated content, encouraging users to express their thoughts and opinions with greater clarity and respect.

The collaborative moderation module (105) introduces a novel approach to content evaluation by enabling multiple moderators to collaboratively assess and categorize content. This framework encourages collective decision-making, facilitating the establishment of consensus-based content classification. Moderators within this module can flag comments or posts for review by other moderators, ensuring a comprehensive and well-informed evaluation process.

The profile management module (106) tracks and displays true positive trolling counts, providing a quantitative assessment of the effectiveness of content moderation. Moreover, this module enforces temporary commenting restrictions upon the identification of trolling behavior, creating a deterrence mechanism against abusive content. Users marked as “allowed” bypass moderation for future comments, while users marked as “blocked” have their comments withheld from moderation, ensuring a controlled and respectful content environment.

The system continuously evolves through user engagement and behavior analysis. By studying user interactions and engagement patterns, the system refines its troll detection models and enhances its suggestions algorithms. This iterative process ensures that the system remains adaptable and effective in tackling emerging forms of trolling and promoting positive online interactions.

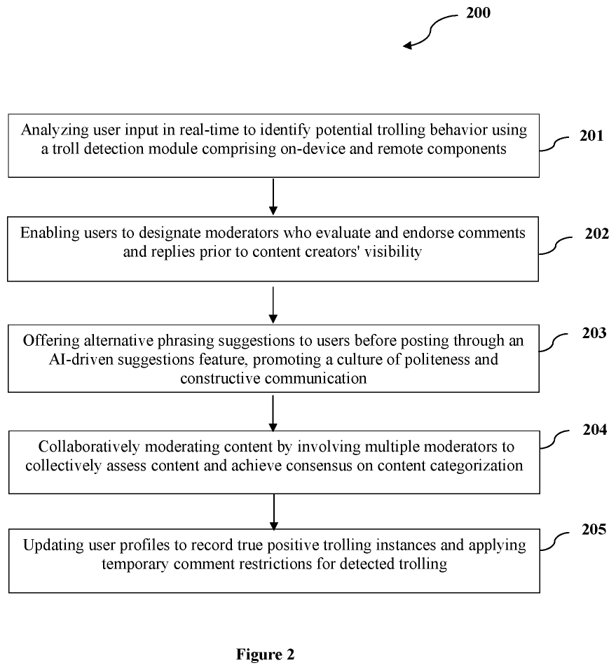

FIG. 2 illustrates a flow diagram depicting a method (200) for anti-trolling and content moderation on an online platform. The method progresses through a sequence of distinct steps, commencing with step (201), which entails the real-time analysis of user input to discern potential trolling behavior, utilizing a troll detection module encompassing both on-device and remote components. Moving to step (202), users are empowered to designate moderators responsible for evaluating and endorsing comments and replies before their visibility to content creators. Advancing further, step (203) introduces alternative phrasing suggestions to users before their posts, facilitated by an AI-driven suggestions feature, thereby fostering a culture of politeness and constructive communication. This seamless progression leads to step (204), wherein content is collaboratively moderated with the engagement of multiple moderators working collectively to assess content and achieve consensus on its categorization. Finally, step (205) involves updating user profiles to chronicle instances of true positive trolling and the implementation of temporary comment restrictions upon the detection of trolling behavior.

There are several advantages of the present invention, including its transformative impact on online interactions and content moderation. One primary advantage lies in the integration of a robust anti-trolling mechanism. Through the implementation of real-time troll detection models, the invention effectively intercepts and prevents the propagation of offensive content at its source. This proactive approach contributes to a more welcoming and secure digital space, fostering meaningful and constructive conversations.

Further, another advantage of the present invention is that it introduces a collaborative moderation framework. Users gain the ability to nominate moderators who assess and approve comments and replies before the user or content creator visibility. This participatory moderation not only enhances the accuracy of content oversight but also establishes a sense of shared responsibility within the online community. The collaborative nature of this approach engenders a sense of accountability, leading to a more respectful and productive discourse environment.

Additionally, the invention offers an AI-driven suggestions feature, which presents yet another advantageous facet. By providing users with alternative rephrasing suggestions before posting, the invention promotes the use of considerate and polite language. This, in turn, mitigates the potential for miscommunication and conflicts, further contributing to a harmonious online discourse.

The present invention also fosters transparency and accountability through the display of metrics such as true positive trolling counts. Moderators and users alike gain valuable insights into the effectiveness of content moderation efforts, encouraging a more responsible and respectful use of the platform.

In conclusion, the integrated anti-trolling and content moderation system for an online platform offers a multifaceted approach to elevate online interactions. Its comprehensive features work in tandem to create an environment where courteous communication thrives, trolling behavior is curbed, and collaborative oversight empowers users to actively shape the discourse landscape.

TABLE 1
Reference numbers:

| Components | Reference Numbers |
|---|---|
| System | 100 |
| Online Social Networking Platform | 101 |
| Troll Detection Module | 102 |
| Personalized Moderation Module | 103 |
| AI-driven Suggestions Module | 104 |
| Collaborative Moderation Module | 105 |
| Profile Management Module | 106 |

We claim:

1. An integrated anti-trolling and content moderation system for an online platform, the system (100) comprising:
a. a troll detection module (102) configured to perform real-time analysis of user-generated content, detecting instances of trolling behavior through both on-device and remote components;
b. a personalized moderation module (103) configured to enable the user to nominate moderators;
c. an Artificial Intelligence (AI)-driven suggestions module (104) configured to provide users with alternative rephrasing suggestions before posting, fostering the promotion of polite and constructive communication;
d. a collaborative moderation module (104) configured to facilitate multiple moderators to collaboratively evaluate content and establish consensus on content classification; and
e. a profile management module (105) configured to track and display true positive trolling counts, coupled with the imposition of temporary commenting restrictions upon the identification of trolling behavior.

2. The system as claimed in claim 1, wherein the troll detection module employs custom tokenization and AI model calibration to optimize troll detection accuracy.

3. The system as claimed in claim 1, wherein the nominated moderator assesses and approves comments and replies prior to content creators' visibility.

4. The system as claimed in claim 1, wherein the moderator is able to view the troll detection score for the content and the user's past statistics, flag comments or posts for review by other moderators, and mark users as allowed or blocked.

5. The system as claimed in claim 1, wherein the moderator's approval of a comment or reply is a prerequisite for the content creator's visibility to said comment or reply.

6. The system as claimed in claim 1, wherein comments or replies from the user marked as blocked are prevented from appearing for moderation or being displayed on the platform, ensuring a controlled content environment.

7. The system as claimed in claim 1, wherein users with no specific moderation status remain subject to ongoing content moderation, ensuring a consistent approach to content evaluation and discourse maintenance.

8. The system as claimed in claim 1, wherein user comments or replies from users marked as allowed are directly posted to the platform without undergoing moderation, thereby expediting the visibility of said comments or replies.

9. The system as claimed in claim 1, wherein the temporary commenting restrictions is imposed upon identification of trolling behavior.

10. The system as claimed in claim 1, wherein a user is granted access to statistics pertaining to each moderator, including the count of users and posts moderated by the moderator.

11. The system as claimed in claim 1, wherein users are provided with information regarding the count of false positive instances, true positives, true negatives, and false negatives attributed to each moderator, thereby indicating the moderators' performance in the evaluation and categorization of comments.

12. An integrated anti-trolling and content moderation metho for an online platform, the method (200) comprising the steps of:
a. analyzing user input in real-time to identify potential trolling behavior using a troll detection module comprising on-device and remote components (201);
b. enabling users to designate moderators who evaluate and endorse comments and replies prior to the user or content creator's visibility (202);
c. offering alternative phrasing suggestions to the user before posting through an AI-driven suggestions feature, promoting a culture of politeness and constructive communication (203);
d. collaboratively moderating content by involving multiple moderators to collectively assess content and achieve consensus on content categorization (204); and
e. updating user profiles to record true positive trolling instances and applying temporary comment restrictions for detected trolling (205).
